(19) United States
(12) Patent Application Publication
(10) Pub. No.: US 2009/0179913 A1
(43) Pub. Date: Jul. 16, 2009

(54) Apparatus for image reduction and method thereof

(75) Inventor: Hsieh-Chang Ho, Taipei (TW)

Correspondence Address: BIRCH STEWART KOLASCH & BIRCH, PO BOX 747, FALLS CHURCH, VA, 22040-0747, US

(73) Assignee: Ali Corporation

(21) Appl. No.: 12/007,456

(22) Filed: Jan. 10, 2008

(51) Int. Cl. G09G 5/00

(52) U.S. Cl. 345/615

(57) ABSTRACT

An apparatus for image reduction and a method thereof are used to reduce an original image, wherein the apparatus includes a weighting element, a memory element, a convolution element, and an adder. Moreover, the weighting element generates a plurality of effective weights according to an image reduction ratio. The memory element is used to store the original image. The convolution element connects to the weighting element and the memory element for performing the Convolution calculation. The adder connects to the convolution element for summing the results of the Convolution calculation so as to output a reduced image.

### BACKGROUND OF THE INVENTION

1. Field of the Invention

The present invention relates to an apparatus for image reduction and method thereof, more particularly, to provide an operation of down-sample for reducing the original image.

2. Description of Related Art

The digital display devices, such as liquid crystal displays (LCDs) or the like, have a fixed screen resolution depending on products, so resolution conversion is essential to convert the diverse resolutions of input images into a screen resolution of a display device. Each size of images is reduced to a suitable size, so as to correspond with a fixed LCD size. Therefore, in the JPEG system, the methods of low-pass filtering and down-sampling are usually used to reduce an original image to a reduced image.

During the process of the image reduction, at first, a horizontal subtractor receives the original image and down-samples the horizontal data of the original image, so as to reduce the horizontal image of the original image. Then, a vertical subtractor receives the original image, whose horizontal image is reduced via a buffer, to reduce the vertical image of the original image. Finally, a synchronizer receives the reduced horizontal image and the reduced vertical image to synchronize the reduced images.

According to the above description, the horizontal subtractor and the vertical subtractor need to use a plurality of line buffers or DRAM for achieving the purpose of the image reduction. However, the mass memory device will increase the volume and the production cost.

Furthermore, the conventional system for image reduction is limited by its circuit structure, and that is incapable of providing high precision, low distortion and high resolution to the basic of the low image reduction extremely, such as the ratio 1.1:1.

### SUMMARY OF THE INVENTION

Accordingly, an object of the present invention is to provide the down-sample operation for reducing the original image.

The apparatus for image reduction of the first embodiment of the present invention includes a weighting element, a memory element, a convolution element and an adder. Moreover, the weighting element is used to generate a plurality of effective weights in response to an image reduction ratio. The memory element has a plurality of pixel registers, which are used to store an original image. The convolution element connects to the weighting element and the memory element so as to operate convolution calculation between those effective weights and the original image stored in those pixel registers. The adder connects to the convolution element so as to sum the results of the convolution calculation and output a reduced image.

Additionally, the apparatus for image reduction of the second embodiment of the present invention includes a weighting element, a weighting distributor, a memory element, a convolution element and an adder. Moreover, the weighting element is used to generate a plurality of effective weights in response to an image reduction ratio. The weighting distributor connects to the weighting element so as to receive those effective weights and outputs at least two sub-effective weights. The memory element has a plurality of pixel registers so as to store an original image. The convolution element connects to the weighting distributor and the memory element so as to operate convolution calculation between those sub-effective weights and the original image stored in those pixel registers. The adder connects to the convolution element so as to sum the results of the convolution calculation and outputs a reduced image.

Moreover, the method for image reduction of the first embodiment of the present invention includes the steps of generating a plurality of effective weights in response to an image reduction ratio; then, accessing an original image; moreover, operating convolution calculation between those effective weights and the original image; finally, summing the results of the convolution calculation and outputting a reduced image.

Furthermore, the method for image reduction of the second embodiment of the present invention includes the steps of generating a plurality of effective weights in response to an image reduction ratio; then, outputting two sub-effective weights according to the choosing of those effective weights; next, accessing an original image; after that, operating convolution calculation between those sub-effective weights and the original image; finally, summing the results of the convolution calculation and outputting a reduced image.

### BRIEF DESCRIPTION OF THE DRAWINGS

The various objects and advantages of the present invention will be more readily understood from the following detailed description when read in conjunction with the appended drawing, in which:

FIG. 1 is a diagram of an image reduction system of the present invention;

FIG. 2 is a diagram of the apparatus for image reduction of the first embodiment of the present invention;

FIG. 3 is a diagram of the other apparatus for image reduction of the first embodiment of the present invention;

FIG. 4 is a diagram of the apparatus for image reduction of the second embodiment of the present invention;

FIG. 5 is a flow chart of the method for image reduction of the first embodiment of the present invention; and

FIG. 6 is a flow chart of the method for image reduction of the second embodiment of the present invention.

### DETAILED DESCRIPTION OF THE PREFERRED EMBODIMENTS

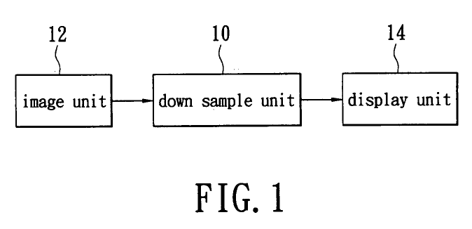

FIG. 1 is a diagram of an image reduction system of the present invention. The image reduction system 1 includes a down-sample unit 10, which connects to an image unit 12 and a display unit 14. Moreover, the down-sample unit 10 receives an original image and reduces the original image for generating a reduced image. The reduced image is suitable for the size of the display unit 14.

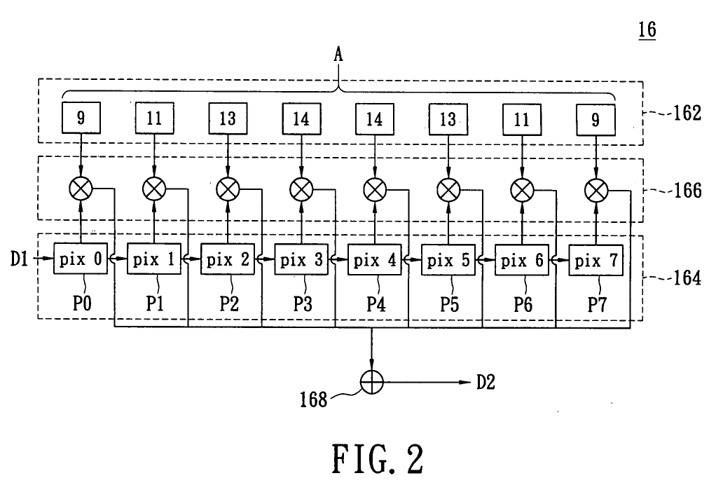

Reference is made to FIG. 2 as well as FIG. 1. FIG. 2 is a diagram of the apparatus for image reduction of the first embodiment of the present invention. The apparatus 16 for image reduction is used in the down-sample unit 10 and includes a weighting element 162, a memory element 164, a convolution element 166 and an adder 168.

Moreover, the weighting element 162 is used to generate a plurality of effective weights in response to an image reduction ratio. The memory element 164 has a plurality of pixel registers, which receives an original image D1 and stores the pixels of the original image D1. Furthermore, the convolution element 166 connects to the weighting element 162 and the memory element 164, so as to operate convolution calculation between those effective weights and the pixels of the original image D1 stored in those pixel registers. The adder 168 connects to the convolution element 166 to sum the results of the convolution calculation, so as to output a reduced image D2.

According to the foregoing statement, the weighting element 162 generates more effective weights while the image reduction ratio is greater, and generates less effective weights while the image reduction ratio is smaller. Besides, for instance, the table 1 is showed the relationship between the number of the effective weights and the size of the image reduction ratio.

TABLE 1

| size of the image | | | | | | | | |
|---|---|---|---|---|---|---|---|---|
| reduction ratio | effective weights | | | | | | | |
| 0~1 | 0 | 0 | 0 | 8 | 0 | 0 | 0 | 0 |
| | 0 | 0 | 0 | 6 | 2 | 0 | 0 | 0 |
| | 0 | 0 | 0 | 4 | 4 | 0 | 0 | 0 |
| | 0 | 0 | 0 | 2 | 6 | 0 | 0 | 0 |
| | 0 | 0 | 0 | 0 | 8 | 0 | 0 | 0 |
| 1~2 | 0 | 0 | 4 | 8 | 4 | 0 | 0 | 0 |
| 2~4 | 0 | 9 | 11 | 12 | 12 | 4 | 0 | 0 |
| 4~6 | 0 | 9 | 11 | 12 | 12 | 11 | 9 | 0 |
| 7~ | 7 | 8 | 8 | 9 | 9 | 8 | 8 | 7 |

Moreover, when the image reduction ratio is greater than 7, whole weights generated from the weighting element 162 are effective (such as 7, 8, 8, 9, 9, 8, 8, 7). Furthermore, when the image reduction ratio is smaller than 7, the parts of the weights generated form the weighting element 162 are effective, and the other parts of the weights are ineffective (such as 0, 9, 11, 12, 12, 11, 9, 0). In other word, the number “0” represents the ineffective weight, and other integer numbers “9” etc. represent the effective weight.

Please refer to FIG. 2 again. The weighting element 162 of the apparatus 16 provides 8 effective weights A which correspond to 8 pixel registers P0˜P7 for the necessity of the high ratio of the image reduction, such as the ratio 8:1. Moreover, 8 pixel registers P0˜P7 of the memory element 164 receive 8 pixels pix0˜pix7 of the original image D1 respectively, and the bit value of each pixels is 8 bits. When 8 pixel registers P0˜P7 finish storing 8 pixels pix0˜pix7 of the original image D1, the convolution element 166 of the apparatus 16 starts to operate convolution calculation between 8 effective weights A and 8 pixel pix0˜pix7 respectively. Furthermore, after the convolution calculation, the adder 168 sums the results of the convolution calculation and outputs a reduced image D2.

Consequently, the apparatus 16 down samples the 8 pixel pix0˜pix7 of the original image D1 into 1 pixel of the reduced image D2 for the necessity of the high image reduction by the operation of averaging filter above.

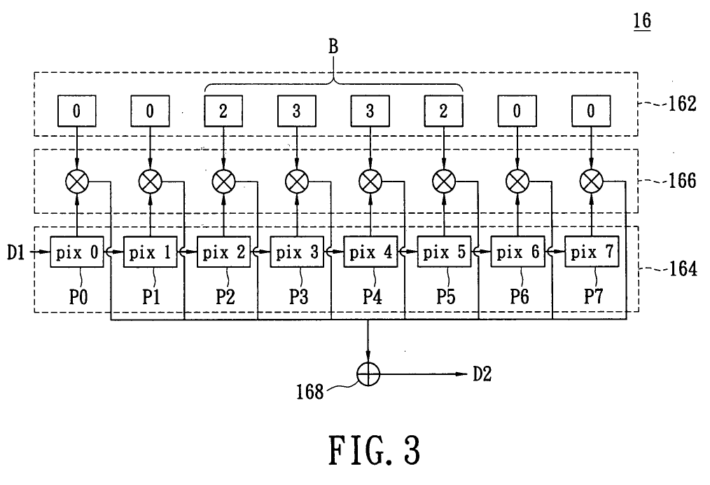

Please refer to FIG. 3. The weighting element 162 of the apparatus 16 provides 4 effective weights B which correspond to 4 pixel registers P2-P5 for the necessity of the low image reduction, such as the ratio 4:1. Moreover, 8 pixel registers P0˜P7 of the memory element 164 receive 8 pixels pix0˜pix7 of the original image D1 respectively. When 8 pixel registers P0˜P7 finish storing 8 pixels pix0˜pix7 of the original image D1, the convolution element 166 of the apparatus 16 starts to operate convolution calculation between 4 effective weights B and 4 pixels pix2˜pix5 respectively. During the operation of the convolution calculation, the other 4 pixels pix0, pix1, pix6, pix7 are ignored. Furthermore, after the convolution calculation, the adder 168 sums the results of the convolution calculation and outputs a reduced image D2.

Consequently, the apparatus 16 down samples the 4 pixels pix2˜pix5 of the original image D1 into 1 pixel of the reduced image D2 for the necessity of the low image reduction by the operation of averaging filter above.

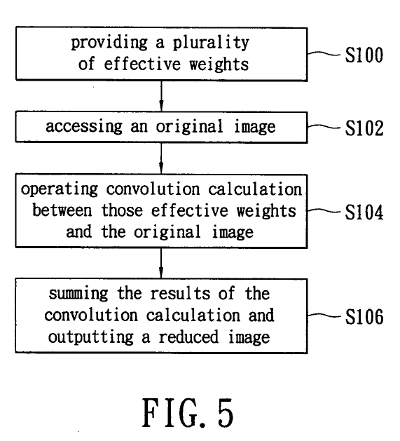

Reference is made to FIG. 5 as well as FIG. 2 and FIG. 3. The operations of the above embodiments of the present invention include the following steps. In the beginning, a weighting element 162 generates a plurality of effective weights in response to an image reduction ratio (S100). Then, using most real pixel of an original image D1 is used for choosing a good starting position and accessing the original image D1 to a memory element 164 according to the good starting position, so as to reduce the side effect of image (S102).

Besides, when meets un-existed pixel of the original image D1, like vertical boundary, the block boundary extend algorithm is used for accessing the original image D1 to the memory element 164 (S102). After that, a convolution element 166 operates convolution calculation between those effective weights and the original image D1 (S104). Finally, an adder 168 sums the results of the convolution calculation and outputs a reduced image D2 (S106).

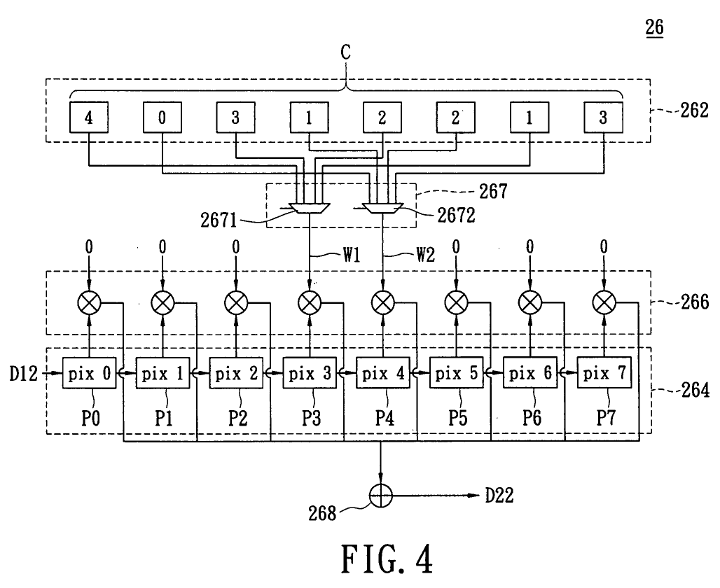

Reference is made to FIG. 4 as well as FIG. 1. FIG. 4 is a diagram of the apparatus for image reduction of the third embodiment of the present invention. The apparatus 26 for image reduction is used in the down-sample unit 10, wherein the apparatus 26 includes a weighting element 262, a weighting distributor 267, a memory element 264, a convolution element 266 and an adder 268.

The weighting element 262 is used to generate a plurality of effective weights in response to an image reduction ratio. The weighting distributor 267 connects to the weighting element 262, so as to receive those effective weights and outputs at least two sub-effective weights. The memory element 264 has a plurality of pixel registers P0-P7 so as to store an original image D12. Furthermore, the convolution element 266 connects to the weighting element 262 and the memory element 264 to operate convolution calculation between those sub-effective weights and the original image D12 stored in those pixel registers P0-P7. The adder 268 connects to the convolution element 266 to sum the results of the convolution calculation to output a reduced image D22.

Please refer to FIG. 4 again. The weighting element 262 of the apparatus 26 provides 8 effective weights C, wherein the 4 effective weights of 8 effective weights C correspond to the input end of a first multiplexer 2671 of the weighting distributor 267, and the other 4 effective weights of 8 effective weights C correspond to the input end of a second multiplexer 2672 of the weighting distributor 267 for the necessity of the extremely low image reduction, such as the ratio 1.1:1.

Moreover, the output ends of the first multiplexer 2671 and the second multiplexer 2672 both connect to the convolution element 266. Furthermore, the multiplexer 2671 and the second multiplexer 2672 output a first sub-effective weight w1 and a second sub-effective weight w2 to the convolution element 266 respectively by choosing the 8 effective weights C in response to the image reduction ratio.

Consequently, 8 pixel registers P0˜P7 of the memory element 264 receive 8 pixels pix0˜pix7 of the original image D1 respectively. When 8 pixel registers P0˜P7 finish storing 8 pixels pix0˜pix7 of the original image D12, the convolution element 266 of the apparatus 26 starts to operate convolution calculation between the two sub-effective weights w1, w2 and 2 pixels pix3˜pix4 respectively. During the operation of the convolution calculation, the other 6 pixels pix0, pix2, pix5, pix6 and pix7 are ignored. Furthermore, after the convolution calculation, the adder 268 sums the results of the convolution calculation and outputs a reduced image D22.

According to the foregoing statement, the apparatus 26 down samples the 2 pixels pix3˜pix4 of the original image D11 into 1 pixel of the reduced image D22 according to the two sub-effective weights w1, w2 chosen from 8 effective weights C. Moreover, the apparatus 26 can provides the necessity of the extremely low image reduction by the operation of averaging filter above.

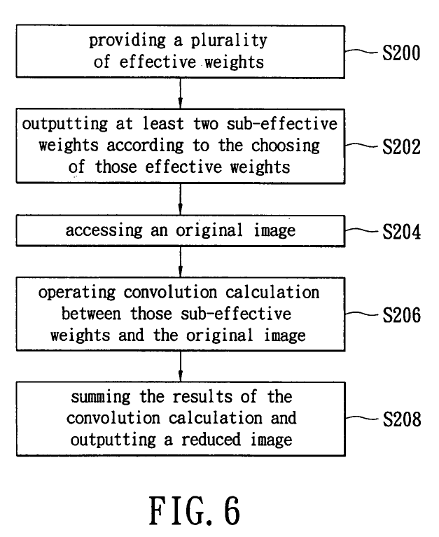

Reference is made to FIG. 6 as well as FIG. 4. The operation of the third embodiment of the present invention includes the following steps: in the beginning, a weighting element 262 generates a plurality of effective weights in response to an image reduction ratio (S200); then, a weighting distributor 267 outputs at least two sub-effective weights according to the choosing of those effective weights (S202). Moreover, using most real pixel of an original image D12 is used for choosing a good starting position and accessing the original image D12 to a memory element 264 according to the good starting position, so as to reduce the side effect of image (S204).

Besides, when meets un-existed pixel of the original image D12, like vertical boundary, the block boundary extend algorithm is used for accessing the original image D12 to the memory element 264 (S204). Next, a convolution element 266 operates convolution calculation between those sub-effective weights and the original image D12 (206). Finally, an adder sums the results of the convolution calculation and outputs a reduced image D22 (S208).

To Sum up, the first and second embodiments of the present invention generate a plurality of effective weights in response to an image reduction ratio and down sample the original image D1 into the reduced image D2 according to the convolution calculation between those effective weights and the original image D1, so as to provide the necessary of the image reduction.

Therefore, the first and second embodiments of the present invention needn't to use mass line buffers or DRAM for achieving the purpose of the image reduction and has the advantages of the smaller volume and the lower production cost.

Additionally, the third embodiment of the present invention generates two sub-effective weights w1, w2 by the two multiplexers 2671, 2672 choosing 8 effective weights generated from the weighting element 262 according to an image reduction ratio. Moreover, the third embodiment of the present invention down samples the original image D12 into the reduced image D22 according to the convolution calculation between the two sub-effective weights w1, w2 and the original image D12, so as to provide the necessary of the extremely low image reduction.

Therefore, the third embodiment of the present invention is capable of providing high precision, low distortion and high resolution to the extremely low image reduction, such as the ratio 1.1:1, needn't to use mass line buffers or DRAM for achieving the purpose of the image reduction, and has the advantages of the smaller volume and the lower production cost.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. An apparatus for image reduction, comprising:
a weighting element for generating a plurality of effective weights in response to an image reduction ratio;
a memory element having a plurality of pixel registers for storing an original image;
a convolution element connected to the weighting element and the memory element for operating convolution calculation between those effective weights and the original image stored in those pixel registers; and
an adder connected to the convolution element for summing the results of the convolution calculation and outputting a reduced image.

2. The apparatus as claimed in claim 1, wherein the number of those effective weights is proportional to the size of the image reduction ratio.

3. An apparatus for image reduction, comprising:
a weighting element for generating a plurality of effective weights in response to an image reduction ratio;
a weighting distributor connected to the weighting element for receiving those effective weights and outputting at least two sub-effective weights;
a memory element having a plurality of pixel registers for storing an original image;
a convolution element connected to the weighting distributor and the memory element for operating convolution calculation between those sub-effective weights and the original image stored in those pixel registers; and
an adder connected to the convolution-element for summing the results of the convolution calculation and outputting a reduced image.

4. The apparatus as claimed in claim 3, wherein the number of those effective weights is proportional to the size of the image reduction ratio.

5. The apparatus as claimed in claim 4, wherein the weighting distributor includes two multiplexers, in which the input ends of two multiplexers connect to the weighting element and the output ends of two multiplexers connect to the convolution element.

6. A method for reducing image to suit the size of a display unit, comprising:
generating a plurality of effective weights in response to an image reduction ratio;
accessing an original image;
operating convolution calculation between those effective weights and the original image; and
summing the results of the convolution calculation and outputting a reduced image.

7. The method as claimed in claim 6, further choosing a good starting position from most real pixel for accessing the original image.

8. The method as claimed in claim 6, further using block boundary extend algorithm for accessing the original image.

9. The method as claimed in claim 6, further outputting at least two sub-effective weights according to the plurality of effective weights before the step of choosing of those effective weights.
